(19) United States
(12) Patent Application Publication
(10) Pub. No.: US 2017/0366466 A1
(43) Pub. Date: Dec. 21, 2017

(54) Method of Reducing Transmission Control Protocol Acknowledgement and Wireless Device Using The Same

(71) Applicant: MEDIATEK INC., Hsin-Chu (TW)

(72) Inventor: Chi-Han Huang, Hsinchu City (TW)

(21) Appl. No.: 15/187,770

(22) Filed: Jun. 20, 2016

(51) Int. Cl. H04L 12/823; H04L 5/00; H04L 12/863; H04W 28/02

(52) U.S. Cl. CPC H04L 47/323; H04W 28/0273; H04L 5/0055; H04L 47/6255

(57) ABSTRACT

A method for a wireless device of a wireless system is disclosed. The method utilizes a byte-in-flight (BIF) value as an indicator to determine whether to drop the transmission control protocol acknowledgement (TCP ACK) packet according to the BIF value, where the BIF value is an amount of data of the wireless connection which is sent by the first device but not acknowledged yet when obtaining the TCP ACK packet. The wireless device establishes a wireless connection with a first device.

### BACKGROUND

The present invention relates to a method of reducing transmission control protocol acknowledgement (TCP ACK) packets and a wireless device using the same, and more particularly, to a method and a wireless device capable of discarding a TCP ACK packet according to a byte-in-flight (BIF) value.

Wireless networks have become pervasive in daily life and vital for wireless communication. There is a constant and crucial need to improve these wireless networks. For example, Transmission Control Protocol Acknowledgement (TCP ACK) packets may collide with data packets and may have redundancy, thereby causing decreased performance in the wireless network.

One method of reducing TCP ACK packets in the art is exploiting an additional buffer to store a plurality of TCP ACK packets and dropping redundant TCP ACK packets in the buffer . Fewer TCP ACK packets are transmitted and a data amount of the TCP ACK packets is therefore reduced. Another method of reducing TCP ACK packets in the art is extracting necessary TCP ACK information from a plurality of TCP ACK packets and exploiting a dedicated channel for the necessary TCP ACK information transmission, in addition to data channel for data packets transmission. A data amount of the TCP ACK packets is also reduced since the necessary TCP ACK information is extracted, and collision of data packets caused by TCP ACK packets is avoided since TCP ACK information is transmitted in the dedicated channel.

However, an additional latency is expected when the TCP ACK packets queue in the buffer, and performance of the wireless network is degraded. In addition, the dedicate channel is needed, and a specific negotiation protocol between a sender and a receiver of the TCP packets is also required, which raise complexity of the wireless network.

Therefore, it is necessary to improve the prior art.

### SUMMARY

It is therefore a primary objective of the present invention to provide a method of discarding a TCP ACK packet according to a byte-in-flight (BIF) value and a wireless device, to improve over disadvantages of the prior art.

An embodiment of the present invention discloses a method for a wireless device in a wireless system. The wireless device establishes a wireless connection with a first device. The method includes obtaining a byte-in-flight (BIF) value when the wireless device obtains a transmission control protocol acknowledgement (TCP ACK) packet; and determining whether to pass the TCP ACK packet to the first device or to drop the TCP ACK packet according to the BIF value; and wherein the BIF value is an amount of data of the wireless connection which is sent by the first device but not acknowledged yet when obtaining the TCP ACK packet.

An embodiment of the present invention further discloses a wireless device in a wireless system. The wireless device establishes a wireless connection with a first device. The wireless device comprises a processing unit; and a storage unit, coupled to the processing unit, configured to store a program code, the program code instructing the processing unit to perform the steps of obtaining a byte-in-flight (BIF) value of the wireless connection when the wireless device obtains a transmission control protocol acknowledgement (TCP ACK) packet; and determining whether to pass the TCP ACK packet to the first device or to drop the TCP ACK packet according to the BIF value; wherein the BIF value is an amount of data of the wireless connection which is sent by the first device but not acknowledged yet when obtaining the TCP ACK packet.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless system according to an embodiment of the present invention.

FIG. 2 is a schematic diagram of a process according to an embodiment of the present invention.

FIG. 3 is a schematic diagram of byte-in-flight (BIF) values with respect to time.

### DETAILED DESCRIPTION

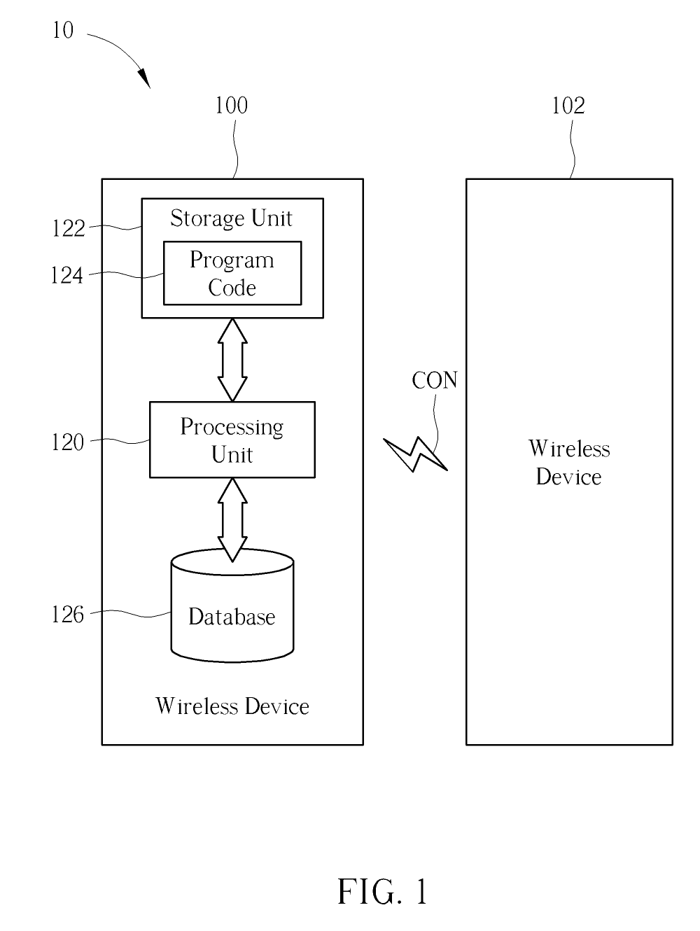

Please refer to FIG. 1, which is a schematic diagram of a wireless system 10 according to an embodiment of the present invention. The wireless system 10 may be a wireless local area network (WLAN) system. The wireless system 10 comprises wireless devices 100, 102. The wireless device 100 may be a wireless router, an access point (AP), or a mobile device with soft AP function, etc. The wireless device 102 may be a mobile device such as a smart phone, a tablet or a note book, etc. A wireless connection CON is established between the wireless device 100 and the wireless device 102. The wireless device 102 sends transmission control protocol (TCP) data packets to the wireless device 100 via the wireless connection CON, and the wireless device 100 sends TCP acknowledgement (TCP ACK) packets to the wireless device 102 after the TCP data packets are received. The wireless device 100 comprises a processing unit 120, a storage unit 122 and a database 126. The processing unit 120 is coupled to the storage unit 122 and the database 126. The storage unit 122 is configured to store a program code 124, where the program code 124 instructs the processing unit 120 to execute a process for reducing an amount of TCK ACK packets to be sent to the wireless device 102. The database 126 is configured to record a connection status of the wireless connection CON, and the reducing process is performed according to the connection status of the wireless connection CON.

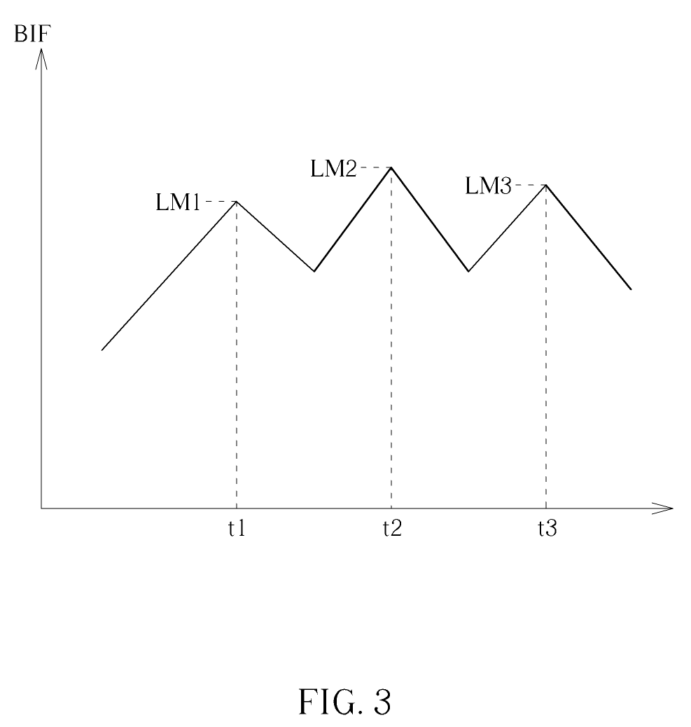

For example, a byte-in-flight (BIF) value is recorded in the database 126. The BIF value indicates an amount of TCP data of the wireless connection CON which is already sent by the wireless device 102 but not acknowledged by the wireless device 100 yet. As the TCP packets are sent by the wireless device 102, the BIF value increases. Once a TCP ACK packet is sent by the wireless device 100, the BIF value decreases and a local maximum of the BIF value is formed. For example, FIG. 3 is a schematic diagram of the BIF value with respect to time t. In FIG. 3, the TCP ACK packets are sent by the wireless device 100 at time instants t1, t2, t3, such that local maximums LM1, LM2, LM3 are formed at the time instants t1, t2, t3. In other words, the BIF value varies with time, and the BIF values at different time instants are recorded in the database 126.

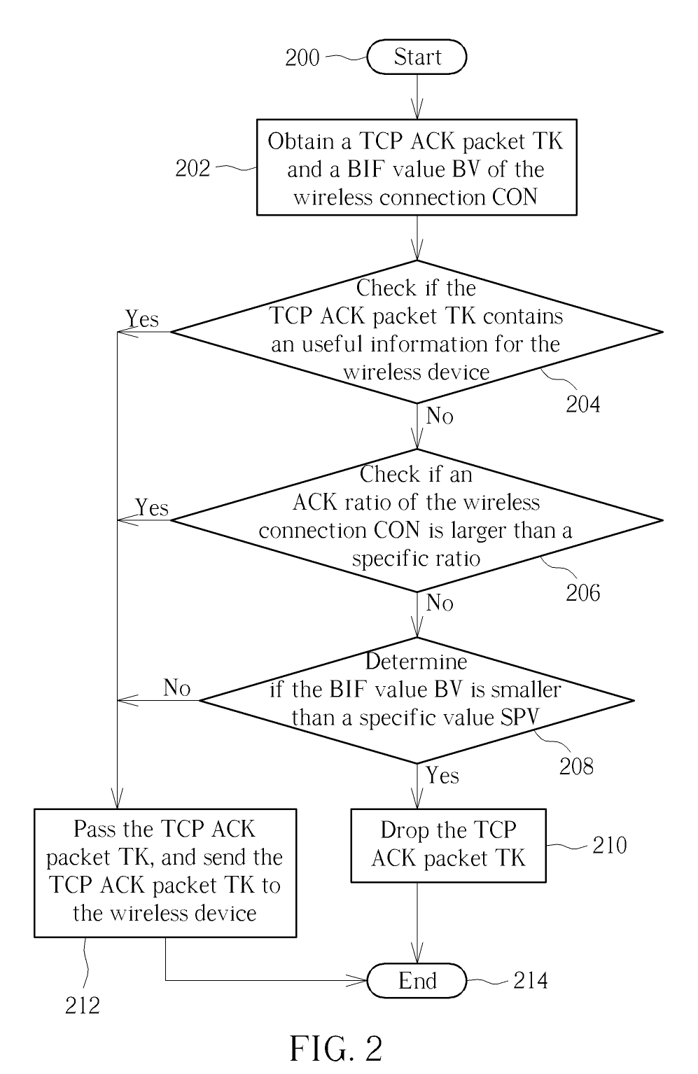

Please refer to FIG. 2, which is a schematic diagram of a process 20 according to an embodiment of the present invention. The process 20 may be compiled as the program code 124 stored in the storage unit 122. The database 126 already records the BIF values at different time instants before the process 20 starts. The process 20 comprises following steps:

### Step 200: Start.

Step 202: Obtain a TCP ACK packet TK and a BIF value BV of the wireless connection CON.
Step 204: Check if the TCP ACK packet TK contains an useful information for the wireless device 102. If yes, go to Step 212; otherwise, go to Step 206.
Step 206: Check if an ACK ratio of the wireless connection CON is larger than a specific ratio. If yes, go to Step 212; otherwise, go to Step 208.
Step 208: Determine if the BIF value BV is smaller than a specific value SPV. If yes, go to Step 210; otherwise, go to Step 212.
Step 210: Drop the TCP ACK packet TK.
Step 212: Pass the TCP ACK packet TK, and send the TCP ACK packet TK to the wireless device 102.

### Step 214: End.

According to the process 20, the wireless device 100 exploits the BIF value as an indicator to determine whether to drop or to pass the TCP ACK packet TK. Compared to the prior art, no latency is caused and there is no need for the additional dedicated channel to transmit the TCP ACK packets in the example of the present invention.

Specifically, in Step 202, the wireless device 100 obtains the TCP ACK packet TK and the BIF value BV. The wireless device 100 may generate the TCP ACK packet TK by itself or receive the TCP ACK packet TK from another electronic device. For example, in an embodiment, the wireless device 100 may be coupled to an electronic device (not illustrated in FIG. 1) via wireline or wirelessly, and the wireless device 100 may pass the TCP ACK packet TK from the electronic device to the wireless device 102. In addition, the BIF value BV, as known as a run-time BIF value, is corresponding to the time instant of the wireless device 100 obtaining the TCP ACK packet TK.

In Step 204, the wireless device 100 checks if the TCP ACK packet TK carries useful information for the wireless device 102. For example, the TCP ACK packet TK may contain a selective ACK (SACK) information, to inform the wireless device 102 of retransmission of a certain part of TCP packet. Thus, the SACK information is a kind of useful information for the wireless device 102, and the TCP ACK packet TK containing the SACK information should be passed to the wireless device 102 immediately. Another useful information for the wireless device 102 is a change of a window size information contained in the TCP ACK packet TK. The window size information indicates how much data is able to be further buffered. If the window size information becomes smaller, the wireless device 102 should send the TCP packets less frequently. If the window size information becomes smaller, the wireless device 102 should send the TCP packets less frequently. Therefore, the TCP ACK packet TK contains useful information for the wireless device 102 when the window size information of the TCP ACK packet TK is changed, and the TCP ACK packet TK with the changed window size information should be passed to the wireless device 102 immediately.

Furthermore, in Step 206, the wireless device 100 checks if the ACK ratio of the wireless connection CON is larger than a specific ratio, where the ACK ratio is a number of TCP packets which are sent by the wireless device 102 but not acknowledged by the wireless device 100 yet. Usually, the ACK ratio should be kept under the specific ratio, so as to maintain performance of the wireless system 10, where the specific ratio may be a predefined ratio specified by the wireless system 10. Thus, the wireless device 100 would directly send the TCP ACK packet TK if the ACK ratio is too large, i.e., larger than the specific ratio.

In Step 208, the wireless device 100 determines if the BIF value BV is smaller than the specific value. The specific value SPV may be a constant value specified by the wireless system 10, or the specific value SPV may be designed according to system requirements. For example, the specific value SPV may be related to a statistic of a plurality of past BIF values, where the plurality of past BIF values are recorded in the database 126 before the wireless 100 obtains the TCP ACK packet TK. The statistic of the plurality of past BIF values may be an average AV of a plurality of local maximums of the plurality of past BIF values, where the average AV may be a moving average of the plurality of local maximums of the plurality of past BIF values within a specific time period. The specific value SPV may be the average AV itself, or be the average AV times a scaling factor, where the scaling factor may be chosen according to system requirements. The larger the scaling factor, the higher chance the TCP ACK packet TK is dropped.

Note that if too many TCP ACK packets are dropped, it would be a higher possibility for the wireless system 10 to enter into a congestion status. Thus, in an embodiment, the specific value SPV maybe the average AV times the scaling factor minus a marginal value MV, where the marginal value MV is a margin configured to prevent the wireless system 10 from being congested. That is, the TCP ACK packet TK may be sent to the wireless device 102 before the wireless system 10 really enters into the congestion status, if the marginal value MV is included in the specific value SPV. The marginal value MV may be related to an ACK frequency, where the ACK frequency is a predefined frequency representing a number of total TCP data divided by the number of total TCP ACKs between two passed TCK ACK packets. In an embodiment, the marginal value MV may be the ACK frequency times a maximum segment size (MSS) of the transmission control protocol. The MSS is known by one skilled in the art, which are not narrated herein.

According to the process 20, the wireless device 100 reduces the TCP ACK packets by discarding the TCP ACK packet TK if the BIF value BV is smaller than the specific value SPV. Exceptions are included in the process 20 when the TCP ACK packet TK contains useful information for the wireless device 102 or the ACK ratio is too high.

Notably, the embodiments stated in the above are utilized for illustrating the concept of the present invention. Those skilled in the art may make modifications and alternations accordingly, and not limited herein. For example, the processing unit 120 may be a microprocessor or an application specific integrated circuit (ASIC). The storage unit 122 may be read-only memory (ROM), random-access memory (RAM), non-volatile memory (e.g., an electrically erasable programmable read only memory (EEPROM) or a flash memory), CD-ROMs, magnetic tapes, floppy disks, optical data storage devices, etc., and not limited herein.

In summary, the present invention exploits the BIF value as the indicator to determine whether to drop or to pass the TCP ACK packet. Therefore, no extra latency is caused and there is no need for the additional dedicated channel to transmit the TCP ACK packets .

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a wireless device in a wireless system, the method comprising:
obtaining a byte-in-flight (BIF) value when the wireless device obtains a transmission control protocol acknowledgement (TCP ACK) packet; and
determining whether to pass the TCP ACK packet to a first device or to drop the TCP ACK packet according to the BIF value;
wherein the BIF value is an amount of data of a wireless connection which is sent by the first device but not acknowledged yet when obtaining the TCP ACK packet.

2. The method of claim 1, wherein the step of determining whether to pass the TCP ACK packet to the first device or to drop the TCP ACK packet according to the BIF value comprises:
dropping the TCP ACK packet when the BIF value is smaller than a specific value.

3. The method of claim 2, wherein the specific value is related to a statistic of a plurality of past BIF values.

4. The method of claim 3, wherein the statistic of the plurality of past BIF values is an average of a plurality of local maximums of the plurality of past BIF values.

5. The method of claim 3, wherein the specific value is the statistic of the plurality of past BIF values times a scaling factor.

6. The method of claim 3, wherein the specific value is the statistic of the plurality of past BIF values times a scaling factor minus a marginal value.

7. The method of claim 6, wherein the margin value is related to an ACK frequency, and the ACK frequency is a number of TCP packets between two passed ACK packets.

8. The method of claim 7, wherein the margin value is the ACK frequency times a maximum segment size (MSS).

9. The method of claim 1, further comprising:
passing the TCP ACK packet when an ACK ratio is larger than a specific ratio before determining whether to pass or to drop the TCP ACK packet according to the BIF value;
wherein the ACK ratio is a number of TCP packets which are sent by the first device but not acknowledged yet.

10. The method of claim 1, further comprising:
passing the TCP ACK packet when the TCP ACK packet contains a selective ACK (SACK) information for the first device before determining whether to pass or to drop the TCP ACK packet according to the BIF value.

11. A wireless device in a wireless system, comprising:
a processing unit; and
a storage unit, coupled to the processing unit, configured to store a program code, the program code instructing the processing unit to perform following steps:
obtaining a byte-in-flight (BIF) value when the wireless device obtains a transmission control protocol acknowledgement (TCP ACK) packet; and
determining whether to pass the TCP ACK packet to a first device or to drop the TCP ACK packet according to the BIF value;
wherein the BIF value is an amount of data of a wireless connection which is sent by the first device but not acknowledged yet when obtaining the TCP ACK packet.

12. The wireless device of claim 11, wherein the program code further instructs the processing unit to perform the following step, for determining whether to pass the TCP ACK packet to the first device or to drop the TCP ACK packet according to the BIF value:
dropping the TCP ACK packet when the BIF value is smaller than a specific value.

13. The wireless device of claim 12, wherein the specific value is related to a statistic of a plurality of past BIF values.

14. The wireless device of claim 13, wherein the statistic of the plurality of past BIF values is an average of a plurality of local maximums of the plurality of past BIF values.

15. The wireless device of claim 13, wherein the specific value is the statistic of the plurality of past BIF values times a scaling factor.

16. The wireless device of claim 13, wherein the specific value is the statistic of the plurality of past BIF values times a scaling factor minus a marginal value.

17. The wireless device of claim 16, wherein the margin value is related to an ACK frequency, and the ACK frequency is a number of TCP packets between two passed ACK packets.

18. The wireless device of claim 17, wherein the margin value is the ACK frequency times a maximum segment size (MSS).

19. The wireless device of claim 11, wherein the program code further instructs the processing unit to perform the following step:
passing the TCP ACK packet when an ACK ratio is larger than a specific ratio before determining whether to pass or to drop the TCP ACK packet according to the BIF value;
wherein the ACK ratio is a number of TCP packets which are sent by the first device but not acknowledged yet.

20. The wireless device of claim 11, wherein the program code further instructs the processing unit to perform the following step:
passing the TCP ACK packet when the TCP ACK packet contains a selective ACK (SACK) information for the first device before determining whether to pass or to drop the TCP ACK packet according to the BIF value.
